(19) United States
(12) Patent Application Publication
(10) Pub. No.: US 2016/0148261 A1
(43) Pub. Date: May 26, 2016

(54) SYSTEM FOR CONTEXTUALIZING GEOCODABLE QUERIES

(71) Applicants: Arnold Binas, Kirribilli (AU); Derek Coatney, San Jose, CA (US); Doruk Bozdag, Sunnyvale, CA (US)

(72) Inventors: Arnold Binas, Kirribilli (AU); Derek Coatney, San Jose, CA (US); Doruk Bozdag, Sunnyvale, CA (US)

(73) Assignee: GOOGLE INC., Mountain View, CA (US)

(21) Appl. No.: 13/598,505

(22) Filed: Aug. 29, 2012

(51) Int. Cl. G06Q 30/02

(52) U.S. Cl. CPC G06Q 30/0256; G06Q 30/0277

(57) ABSTRACT

A system for contextualizing geocodable queries may include one or more processors and a memory. The one or more processors may receive a search term associated with a user. The one or more processors may determine whether the search term is geocodable. If the search term is geocodable, the one or more processors may determine a previous query associated with the user, and retrieve an advertisement based at least in part on the search term and the previous query. If the search term is not geocodable, the one or more processors may retrieve an advertisement based at least in part on the search term and exclusive of the previous query. In one or more implementations, at least partially contemporaneous to retrieving the advertisement, the one or more processors may retrieve a search result.

### TECHNICAL FIELD

The present description relates generally to geocodable queries, and more particularly, but not exclusively, to contextualizing geocodable queries.

### BACKGROUND

In online advertising systems, advertisements are presented to users on web pages, such as on search results pages generated by search engines. If a user clicks on an advertisement on a web page, and/or performs some other action subsequent to clicking on an advertisement, the operator of the web page may be compensated, such as by the entity or business associated with the advertisement. In some instances, the likelihood of a user clicking on an advertisement may be directly correlated to the relevance that the advertisement has to the user, such as the relevance of the advertisement to a search being performed by the user. Thus, it may be desirable for web page operators, such as search engine operators, to present advertisements to users that have relevance to the users, such as advertisements that are relevant to search queries performed by the users, in order to increase the likelihood that the users will click on one of the presented advertisements.

### SUMMARY

The disclosed subject matter relates to a computer implemented method for contextualizing geocodable queries. The method may include receiving, using one or more computing devices, a first query associated with a user. The method may further include determining, using the one or more computing devices, whether the first query exclusively comprises terms that are geocodable, and when the first query exclusively comprises the terms that are geocodable, determining, using the one or more computing devices, a previous query associated with the user. The method may further include retrieving, using the one or more computing devices, an advertisement based at least in part on the first query and the previous query.

In another aspect, the computer implemented method may include receiving, using one or more computing devices, a first query associated with a user. The method may further include providing, using the one or more computing devices, the first query to a location extraction module. The method may further include receiving, using the one or more computing devices, a first indication from the location extraction module of whether the first query exclusively comprises terms that are associated with geolocations and, when the first indication indicates that the first query exclusively comprises the terms that are associated with the geolocations, providing, using the one or more computing devices and to an advertisement retrieval system, the first query and a second indication that the first query should be combined with a previous query associated with the user, otherwise providing, using the one or more computing devices, the first query to the advertisement retrieval system. The method may further include receiving, using the one or more computing devices, an advertisement from the advertisement retrieval system.

The disclosed subject matter also relates to a system for contextualizing geocodable queries. The system may include one or more processors and a memory including instructions that, when executed by the one or more processors, cause the one or more processors to: receive a search term associated with a user, determine whether the search term is geocodable, exclusively when the search term is geocodable, determine a query associated with the user, and retrieve an advertisement based at least in part on the search term and the query.

The disclosed subject matter also relates to a machine-readable medium embodying instructions that, when executed by a machine, allow the machine to perform a method for contextualizing geocodable queries. The method may include providing a first query that relates to a topic. The method may further include providing a second query that exclusively comprises geocodable terms, the second query being provided after the first query. The method may further include receiving a search result based at least in part on the second query. The method may further include when the first query satisfies a criterion, based on the topic, that is independent of the second query, receiving a first advertisement that is selected based at least in part on the first query and the second query, and when the first query does not satisfy the criterion, receiving a second advertisement, distinct from the first advertisement, that is selected based at least in part on the second query and exclusive of the first query.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment that may implement a system for contextualizing geocodable queries.

FIG. 2 illustrates a flow diagram of an example process for a system for contextualizing geocodable queries.

FIG. 3 illustrates a flow diagram of an example process for a system for contextualizing geocodable queries.

FIG. 4 illustrates a flow diagram of an example process for a system for contextualizing geocodable queries.

FIG. 5 conceptually illustrates an electronic system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

In some instances a search query performed by a user may be so broad that there may be a large number of advertisements that are relevant to the search query, but only a subset of the advertisements may have relevance to the user, e.g. only a subset of the advertisements may have relevance to the user's intent in performing the search query. For example, if a user provides a search query that only includes the name of a city, such as “Chicago” there may be a large number of advertisements that are relevant to the search query, such as advertisements pertaining to any business that is operated in Chicago, advertisements pertaining to businesses that coordinate travel to Chicago, etc. However, only a subset of the advertisements may have relevance to the user, e.g. relevance to the user's intent in searching for Chicago. Thus, it may be desirable to present the user with the subset of the advertisements that have relevance to the user, in order to increase the likelihood that the user will click on one of the presented advertisements.

In the subject system for contextualizing geocodable queries, a query associated with a user may be received. The system may determine whether the query exclusively includes geocodable terms (e.g., a geocodable query), such as city names, state names, country names, addresses, geographic locations, or generally any terms that are capable of being geocoded. If the query exclusively includes geocodable terms, a previous query that is associated with the user may be determined, such as a previous search query performed by the user. In order to provide context to the geocodable query, the previous query may be appended to the geocodable query, and advertisements may be retrieved based on a combination of the queries, such as by using the geocodable query as a targeting location and using the previous query when determining what keywords to match to when determining eligible advertisements. The retrieved advertisements may be presented to the user. Since the advertisements presented to the user are retrieved based at least in part on both the geocodable query and the previous query, there may be a higher likelihood that the presented advertisements will have relevance to the user than if the advertisements had been retrieved based solely on the geocodable query.

The phrase “geocodable” as used herein encompasses its plain and ordinary meaning and, if not otherwise included in its plain and ordinary meaning, may also refer to whether a term, group of terms, or a query, are capable of being geocoded. In one or more examples, a term or a query may be capable of being geocoded when the term or the query describes a geographic location, such as a city name, a state name, a country name, an addresses, or generally any term or query that describes a geographic location.

For example, a first query may be received from a user for “Bears,” and a second query may be subsequently received from the user for “Chicago.” If advertisements are retrieved for the user based on the query for “Chicago” exclusive of the query for “Bears,” then the user may be presented with advertisements that are generally relevant to Chicago, but that might not be specifically relevant to the user's intent in searching for Chicago, e.g. to find information that pertains to Chicago but that is also relevant to the Chicago Bears football team. As such, there may be a low likelihood that the presented advertisements will have relevance to the user, and therefore a low likelihood that the user will click on one of the presented advertisements. However, if advertisements are retrieved based both on “Chicago” and “Bears,” then the user may be presented with advertisements that are specifically relevant to the Chicago Bears, such as advertisements for ticket brokers in Chicago, advertisements for restaurants near Soldier's Field (where the Chicago Bears play), etc. As such, there may be a high likelihood that the presented advertisements will have relevance to the user, and therefore a high likelihood that the user will click on one of the presented advertisements.

In one example, in order to determine whether a query exclusively includes geocodable terms, the system may attempt to geocode each term of the query, such as by using a location extraction algorithm. However, if the system has existing latency requirements it may be impractical to attempt to geocode each term of the query, e.g. it may not be possible to attempt to geocode each term of the query within the existing system latency requirements. In these instances, the system may determine whether the query exclusively includes geocodable terms without actually geocoding each term of the query. In other words, the system may determine whether the terms of the query are associated with geographic locations without actually determining what the associated geographic locations are. Alternatively, or in addition, the system may attempt to geocode the terms of the query using a location extraction algorithm that has a reduced depth of knowledge of geocodable terms. For example, a geocodable terms database may be reduced in size by some factor, such as one-third, and the location extraction algorithm may utilize the reduced geocodable terms database. In this manner, the latency incurred for determining whether the query includes exclusively geocodable terms may be reduced. Alternatively, or in addition, the system may annotate or classify each term of the query as being a geocodable term, or as being a term having some other classification, such as by performing pattern-matching on the terms of the query. The system may then determine whether all of the terms of the query have been annotated or classified as geocodable terms.

The method of annotating or classifying each term of the query, or using a location extraction algorithm that has a reduced depth of knowledge of geocodable terms, to determine whether the query exclusively includes geocodable may achieve a similar level of precision, but a lower level of recall, as the method of attempting to geocode each term of the query using a location extraction algorithm that has the non-reduced depth of knowledge of geocodable terms. However, the lower level of recall may be acceptable for some systems with existing latency requirements, such as in web-based search implementations where query volume and baseline monetization are both high, and therefore improving targeting on a subset of queries that exclusively include geocodable terms may be valuable. In addition, the system may further reduce latency in web-based search implementations by retrieving search results based on the geocodable query at least partially contemporaneous to retrieving advertisements based on both the geocodable query and the previous query.

In one or more implementations, if the previous query is not suitable for being appended to the geocodable query, e.g. the previous query does not satisfy the criterion, another previous query may be selected to be appended to the geocodable query, or no query may be appended to the geocodable query. In these one or more implementations, if another previous query is selected, the system may verify that the another previous query satisfies the criterion prior to appending the another previous query to the received query.

For explanatory purposes, queries are generally discussed herein in the context of search queries received from users. However, a query may also refer to information that characterizes, or summarizes, a web page visited by a user, such as in a display advertising system. In this instance, a query may be received from a server that is hosting a web page visited by a user, and the query may characterize or classify the web page such that advertisements relevant to the web page may be retrieved for presentation to the user.

II. Example Network Environments for a System for Contextualizing Geocodable Queries

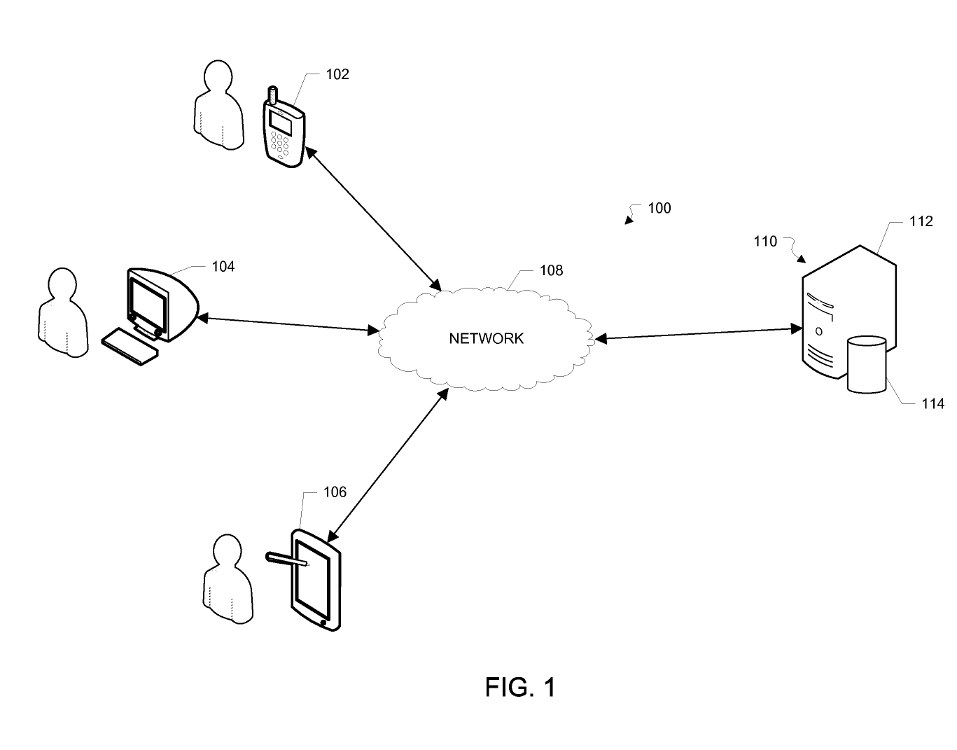

FIG. 1 illustrates an example network environment 100 which may implement a system for contextualizing geocodable queries. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The network environment 100 may include a number of electronic devices 102, 104, 106 communicably connected to a server 110, such as by network 108. In another example, some or all of the electronic devices 102, 104, 106 may be communicably connected to one another, such as by the network 108, and some or all of the electronic devices 102, 104, 106 may not be communicably connected to the server 110. The network 108 may be a public communication network (such as the Internet, cellular data network, dialup modems over a telephone network) or a private communications network (such as private local area network (“LAN”), leased lines). The network 108 may also include, but is not limited to, any one or more of the following network topologies, including a bus network, a star network, a ring network, a mesh network, a star-bus network, a tree or hierarchical network, and the like.

In some example embodiments, the electronic devices 102, 104 and 106 can be computing devices such as laptop or desktop computers, smartphones, personal digital assistants (“PDAs”), portable media players, tablet computers, televisions or other displays with one or more processors coupled thereto and/or embedded therein, or other appropriate computing devices that can be used to for displaying a web page or web application. In the example of FIG. 1, the electronic device 102 is depicted as a smartphone, the electronic device 104 is depicted as a desktop computer and the electronic device 106 is depicted as a tablet device.

In one example, server 110 may be a single computing device such as a computer server. In another example, server 110 may represent more computing devices (such as a cloud of computers and/or a distributed system) that are communicatively coupled, such as communicatively coupled over the network 108, that collectively, or individually, perform one or more functions that can be performed server-side, such as location extraction, query classification, search result retrieval, advertisement retrieval, advertisement serving, and/or generally any functions that can be performed server-side. The one or more computing devices of the server 110 may be geographically collocated and/or the one or more devices may be disparately located. The server 110 may be coupled with various databases, storage services, or other computing devices. The server 110, and the coupled databases, storage services, or other computing devices may be geographically collocated, or may be disparately located.

The server 110 may host a web server that is communicatively coupled to client devices, such as web browsers of client devices (e.g., electronic devices 102, 104 or 106) via network 108. In one example, the subject system may be integrated into one or more of a location extraction system, a query classification system, a search engine, an advertisement retrieval system and/or an advertisement serving system hosted at server 110. In another example, the subject system may be hosted at server 110 and may be communicatively coupled to one or more remote servers hosting one or more other location extraction systems, query classification systems, search engines, advertisement retrieval systems and/or an advertisement serving systems (e.g., one or more remote servers) over one or more networks (e.g., network 108).

In operation, a user may interact with one of the electronic devices 102, 104, 106, such as the electronic device 102, and the electronic device 102 may provide a query to the server 110. For example, a user may input a search query on the electronic device 102 and the electronic device 102 may provide the search query to the server 110, such as over the network 108. Alternatively, or in addition, the user may view a web page on the electronic device 102 and the electronic device 102 may provide information that characterizes, or summarizes the web page to the server 110, such as over the network 108.

The server 110 may determine whether the received query exclusively includes geocodable terms, such as by providing the query to a location extraction engine of the server 110. If the query exclusively includes geocodable terms, the server 110 may identify a previous query received from the user, such as a previous search query received from the user. The server 110 may determine whether the previous query satisfies a criterion that is independent of the query, such as by providing the previous query to a query classification module of the server 110. If the previous query satisfies the criterion, the server 110 may retrieve one or more advertisements based at least in part on the query and the previous query. For example, the server 110 may provide the query, and an indication that a previous query should be used when determining what keywords to match to when determining the eligible advertisements and/or that the previous query should be combined with and/or appended to the query, to an advertisement retrieval engine of the server 110. If the previous query does not satisfy the criterion and/or if the query does not include exclusively geocodable terms, the server 110 may retrieve one or more advertisements based on the query exclusive of the previous query. For example, the server 110 may provide the query to an advertisement retrieval system.

The server 110 may provide the one or more advertisements to the electronic device 102 for presentation to the user. In the instance of a search query received from the electronic device 102, the server 110 may retrieve one or more search results based at least in part on the search query, such as by providing the search query to a search engine of the server 110. The server 110 may retrieve the one or more search results at least partially contemporaneous to retrieving the one or more advertisements. The one or more search results may be provided to the electronic device 102 for presentation to the user.

III. Example Processes for a System for Contextualizing Geocodable Queries

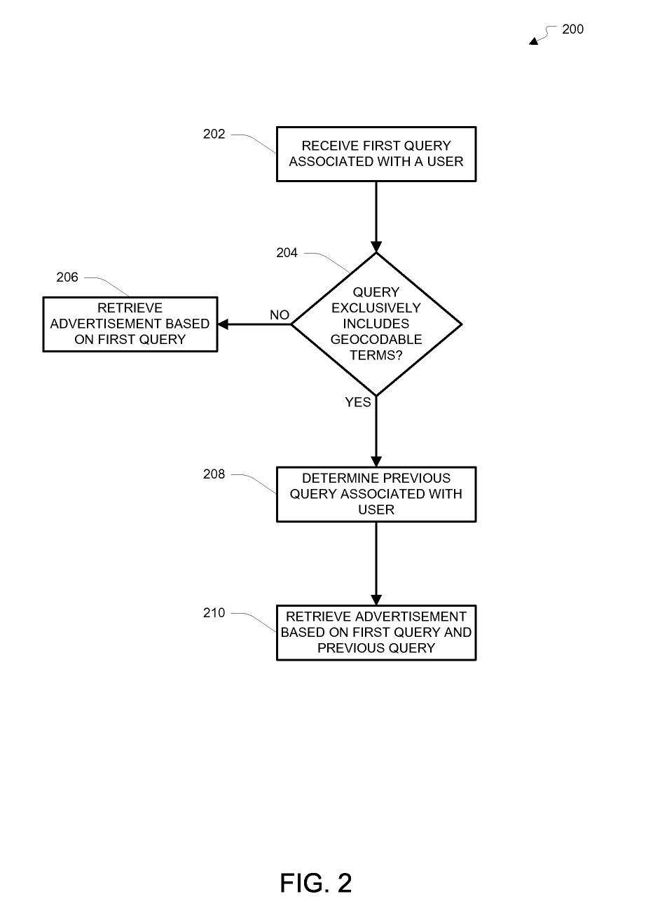

FIG. 2 illustrates a flow diagram of example process 200 for contextualizing geocodable queries. For explanatory purposes, example process 200 is described herein with reference to example network environment 100 of FIG. 1; however, example process 200 is not limited to example network environment 100 of FIG. 1. Further for explanatory purposes, the blocks of example process 200 are described herein as occurring in serial, or linearly. However, multiple blocks of example process 200 may occur in parallel. In addition, the blocks of example process 200 need not be performed in the order shown and/or one or more of the blocks of example process 200 need not be performed.

In block 202, the server 110 receives a first query associated with a user. For example, the first query associated with the user may be a search query provided by a user interacting with one of the electronic devices 102, 104, 106. Alternatively, or in addition, the first query associated with the user may include information that characterizes a web page being viewed by a user interacting with one of the electronic devices 102, 104, 106, such as in a display advertising system.

In block 204, the server 110, such as a location extraction module or device of server 110, may determine whether the first query exclusively includes geocodable terms. For example, the server 110 may determine whether the terms of the first query are geocodable without geocoding the terms. Alternatively, or in addition, the server 110 may attempt to geocode the terms of the first query using a location extraction algorithm that has a reduced depth of knowledge of geocodable terms. Alternatively, or in addition, the server 110 may annotate or classify each term of the first query as being a geocodable term, or as being a term having some other classification, such as by performing pattern-matching on the terms of the query. The server 110 may then determine whether all of the terms of the first query have been annotated or classified as geocodable terms.

If, in block 204, the server 110 determines that the query exclusively includes geocodable terms, the server 110 moves to block 208. In block 208, the server 110 determines a previous query associated with the user, and, in block 210, the server 110 retrieves an advertisement based on the first query and the previous query. For example, the server 110 may provide the first query and an indication that a previous query associated with the user should be used when determining what keywords to match to when determining the eligible advertisements and/or that the previous query should be combined with and/or appended to the first query, to an advertisement retrieval system or an advertisement serving system of the server 110. The server 110 may provide the advertisement to the electronic device 102 for presentation to the user.

In one or more implementations, the server 110 may determine whether the previous query satisfies a criterion before retrieving an advertisement based on the first query and the previous query. For example, the server 110 may determine whether a topic of the previous query is included on a topic whitelist, or is excluded from a topic blacklist. If the previous query does not satisfy the criterion, then the server 110 may not retrieve one or more advertisements based on the first query and the previous query.

If, in block 204, the server 110 determines that the first query does not include exclusively geocodable terms, then the server 110 moves to block 206. In block 206, the server 110 retrieves an advertisement based on the first query, e.g. exclusive of the previous query. For example, the server 110 may provide the first query to an advertisement retrieval system or an advertisement serving system of the server 110.

In one or more implementations, if the first query is a search query, server 110 may retrieve one or more search results based on the first query, such as by providing the first query to a search engine of the server 110. The server 110 may retrieve the one or more search results at least partially contemporaneous to retrieving the advertisement. The server 110 may then provide the one or more search results to the electronic device 102 for presentation to the user.

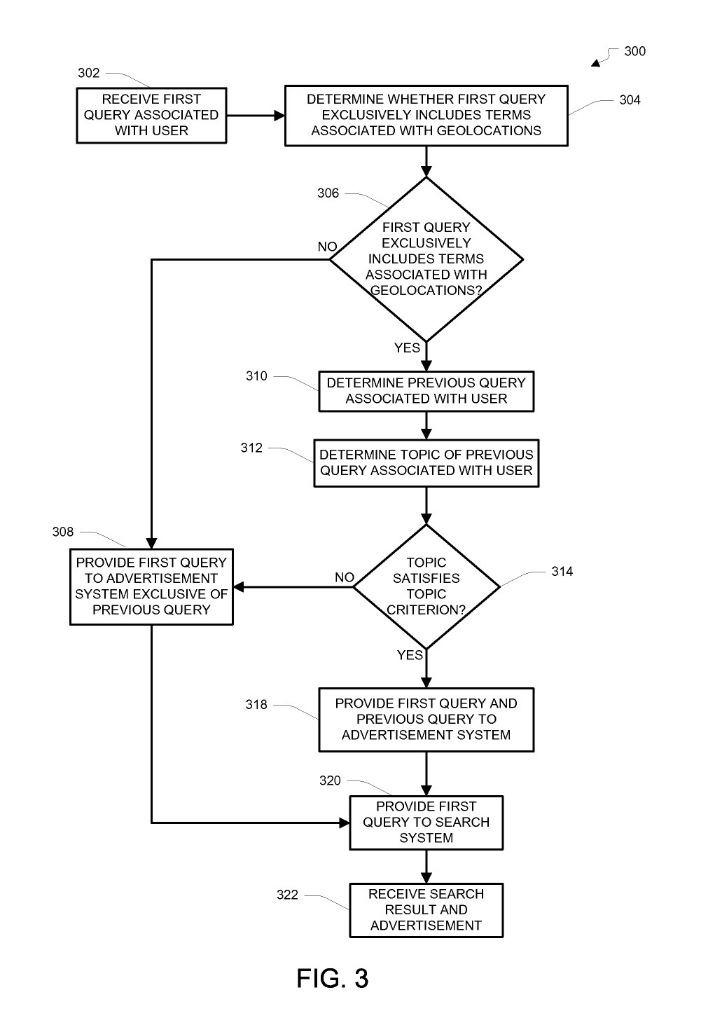

FIG. 3 illustrates a flow diagram of example process 300 for contextualizing geocodable queries. For explanatory purposes, example process 300 is described herein with reference to example network environment 100 of FIG. 1; however, example process 300 is not limited to example network environment 100 of FIG. 1. Further for explanatory purposes, the blocks of example process 300 are described herein as occurring in serial, or linearly. However, multiple blocks of example process 300 may occur in parallel. In addition, the blocks of example process 300 need not be performed in the order shown and/or one or more of the blocks of example process 300 need not be performed.

In block 302, the server 110 receives a first query associated with a user. For example, the first query associated with the user may be a search query provided by a user interacting with one of the electronic devices 102, 104, 106. Alternatively, or in addition, the first query associated with the user may include information that characterizes a web page being viewed by a user interacting with one of the electronic devices 102, 104, 106, such as in a display advertising system.

In block 304, the server 110, such as a location extraction module or device of server 110, may determine whether the first query exclusively includes geocodable terms. For example, the server 110 may determine whether the terms of the first query are geocodable without actually geocoding the terms, such as by determining whether the terms of the first query describe geographic locations without determining what the geographic locations are. Alternatively, or in addition, the server 110 may attempt to geocode the terms of the first query using a location extraction algorithm that has a reduced depth of knowledge of geocodable terms.

If, in block 306, the server 110 determines that the first query exclusively includes geocodable terms, the server 110 moves to block 310. In block 310, the server 110 determines a previous query associated with the user. The previous query associated with the user may be a previous search query received from the user, information that characterizes or summarizes a web page previously visited by the user, such as in a display advertising system, or generally any previous query received from, or associated with, the user.

In block 312, the server 110 determines a topic of the previous query associated with the user, such as by providing the previous query to a query classification module of the server 110. In block 314, the server 110 determines whether the topic of the previous query satisfies a topic criterion that is independent of the first query, e.g. the first query has no bearing on whether the previous query satisfies the topic criterion. In one or more implementations, the topic criterion may include a topic whitelist and/or a topic blacklist. In the instance of a topic whitelist, the topic criterion may be satisfied if the topic is included in the topic whitelist, and in the instance of a topic blacklist, the topic criterion may be satisfied if the topic is not included in the topic blacklist. Alternatively, or in addition, the server 110 may determine whether the previous query exclusively includes geocodable terms. In one or more implementations, the topic criterion may satisfied when the previous query does not exclusively include geocodable terms, and the topic criterion may not be satisfied when the previous query exclusively includes goecodable terms.

If, in block 314, the server 110 determines that the topic of the previous query satisfies the topic criterion, the server 110 moves to block 318. In block 318, the server 110 provides the first query and the previous query to an advertisement retrieval and/or serving system, such as an advertisement retrieval and/or serving modules of the server 110. In one or more implementations, the server 110 may provide the first query and an indication that the previous query should be used when determining what keywords to match to when determining the eligible advertisements and/or that the previous query should be combined with and/or appended to, the first query, to the advertisement retrieval system.

If, in block 306, the server 110 determines that the first query does not exclusively include geocodable terms, or if, in block 314, the server 110 determines that the topic of the previous query does not satisfy the topic criterion, the server 110 moves to block 308. In block 308, the server 110 provides the first query to the advertisement retrieval system, e.g. exclusive of the previous query.

In block 320, the server 110 provides the first query to a search engine, such as a search engine module of the server 110. The server 110 may provide the first query to the search engine prior to, or at least partially contemporaneous to, providing the first query and/or the previous query to the advertisement retrieval system. In block 322, the server 110 receives one or more search results, such as from the search engine module of the server 110, and the server 110 receives one or more advertisements, such as from the advertisement retrieval system of the server 110. In one or more implementations, the server 110 may provide the one or more search results and/or the one or more advertisements to the electronic device 102 for presentation to the user.

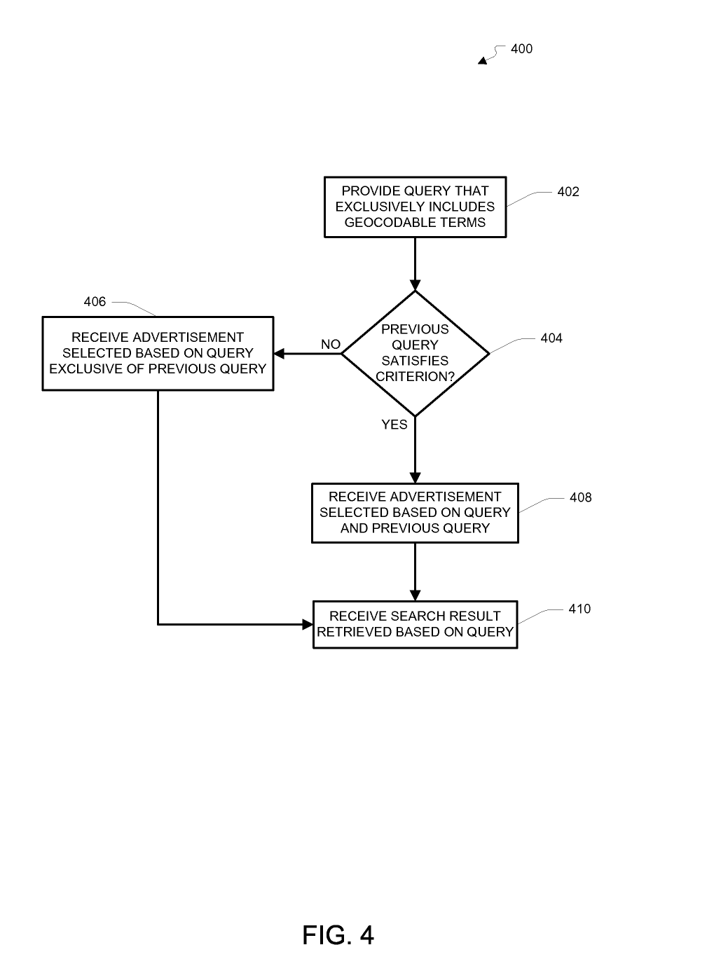

FIG. 4 illustrates a flow diagram of example process 400 for contextualizing geocodable queries. For explanatory purposes, example process 400 is described herein with reference to example network environment 100 of FIG. 1; however, example process 400 is not limited to example network environment 100 of FIG. 1. Further for explanatory purposes, the blocks of example process 400 are described herein as occurring in serial, or linearly. However, multiple blocks of example process 400 may occur in parallel. In addition, the blocks of example process 400 need not be performed in the order shown and/or one or more of the blocks of example process 400 need not be performed.

In block 402, the electronic device 102 provides a query that exclusively includes geocodable terms to the server 110. For example, a user interacting with the electronic device 102 may input a search query that exclusively includes geocodable terms, such as “Chicago.” The electronic device 102 then moves to block 404. If, in block 404, a previous query associated with the user, such as a previous query that was provided by the electronic device 102 to the server 110, satisfies a criterion, the electronic device 102 moves to block 408. For example, if the previous query includes a topic, or is related to a topic, that is included on a topic whitelist, or is excluded from a topic blacklist, then the previous query may satisfy the criterion.

In block 408, the electronic device 102 receives a first advertisement that was selected based on the query and the previous query associated with the user, such as a previous query that the user input to the electronic device 102. For example, the advertisement may have been retrieved using the geolocation of the query provided by the electronic device 102 as a targeting location and the previous query may have been used to determine what keywords to match to when determining the eligible advertisements.

If, in block 404, the previous query does not satisfy the criterion, the electronic device 102 moves to block 406. In block 406, the electronic device 102 receives a second advertisement that is selected based on the query exclusive of the second query. For example, the second advertisement may have been retrieved based on the query exclusive of the second query. In one or more implementations, the second advertisement may be distinct from the first advertisement.

In block 410, the electronic device 102 may receive one or more search results based at least in part on the query and exclusive of the previous query. In one or more implementations, the electronic device 102 may receive the one or more search results at least partially contemporaneous to receiving the first advertisement or the second advertisement. The electronic device 102 may present the one or more search results and the first advertisement, or the second advertisement, to the user, such as on a search results page.

V. Example Systems for Contextualizing Geocodable Queries

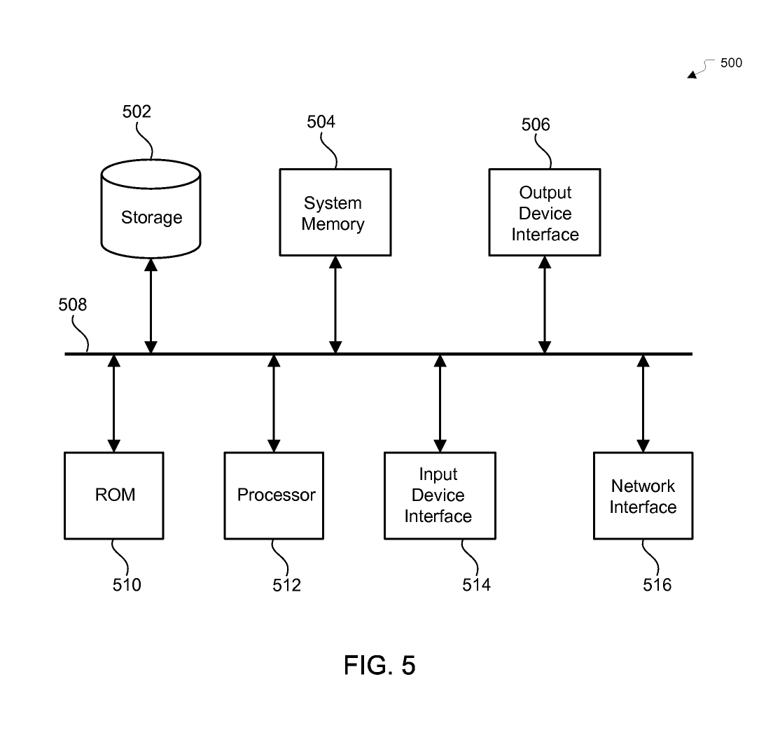

FIG. 5 conceptually illustrates an electronic system with which some implementations of the subject technology are implemented. Electronic system 500 can be a server, computer, phone, PDA, a tablet computer, a television with one or more processors embedded therein or coupled thereto, or generally any electronic device. For example, electronic system 500 can represent part or all of server 110 and/or electronic devices 102, 104, 106, respectively. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for contextualizing geocodable queries in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Alternatively, or in addition, some implementations may be performed using one or more graphics processing units (GPUs).

As used in this specification and any claims of this application, the terms “computer”, “server”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, such as a data server, or that includes a middleware component, such as an application server, or that includes a front end component, such as a client computer having a graphical user interface or a Web browser through which a user can interact with an implementation of the subject matter described in this specification, or any combination of one or more such back end, middleware, or front end components. The components of the system can be interconnected by any form or medium of digital data communication, such as a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of blocks in the processes disclosed is an illustration of example approaches. Based upon design preferences, it is understood that the specific order or hierarchy of blocks in the processes may be rearranged, or that all illustrated blocks may not be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A computer-implemented method for contextualizing geocodable queries, the method comprising:
receiving, using one or more computing devices, a first query associated with a user;
determining, using the one or more computing devices, whether the first query exclusively comprises terms that are geocodable such that each term in the search query is capable of being geocoded;
when the first query does not exclusively comprise terms that are geocodable:
retrieving, using the one or more computing devices, an advertisement based at least in part on the first query; and
when the first query exclusively comprises the terms that are geocodable;
determining, using the one or more computing devices, a previous query associated with the user; and
retrieving, using the one or more computing devices, an advertisement based at least in part on the first query and the previous query.

2. The method of claim 1, wherein the determining, using the one or more computing devices, whether the first query exclusively comprises the terms that are geocodable further comprises:
determining, using the one or more computing devices, whether the first query exclusively comprises the terms that are geocodable without geocoding the first query.

3. The method of claim 1, wherein the determining, using the one or more computing devices, whether the first query exclusively comprises terms that are geocodable further comprises:
annotating, using the one or more computing devices, each term of the first query; and
determining, using the one or more computing devices, whether the first query exclusively comprises the terms that are geocodable based on the annotating of each term of the first query.

4. The method of claim 1, further comprising:
determining, using the one or more computing devices, a topic based at least in part on the previous query.

5. The method of claim 4, further comprising:
determining, using the one or more computing devices, whether the topic satisfies a topic criterion that is independent of the first query.

6. The method of claim 5, wherein the retrieving, using the one or more computing devices, the advertisement based at least in part on the first query and the previous query further comprises:
retrieving, using the one or more computing devices, the advertisement based at least in part on the first query and the previous query exclusively when the topic satisfies the topic criterion, otherwise retrieving, using the one or more computing devices, the advertisement based at least in part on the first query and exclusive of the previous query.

7. The method of claim 5, wherein the determining, using the one or more computing devices, whether the topic satisfies the topic criterion that is independent of the first query further comprises:
determining, using the one or more computing devices, whether the topic is included in a topic whitelist.

8. The method of claim 5, wherein the determining, using the one or more computing devices, whether the topic satisfies the topic criterion that is independent of the first query further comprises:
determining, using the one or more computing devices, whether the topic is excluded from a topic blacklist.

9. The method of claim 1, further comprising:
retrieving, using the one or more computing devices, a search result based at least in part on the first query.

10. The method of claim 9, wherein the retrieving, using the one or more computing devices, the advertisement and the retrieving, using the one or more computing devices, the search result are performed by the one or more computing devices, at least partially contemporaneously.

11. The method of claim 1, wherein the retrieving, using the one or more computing devices, the advertisement based at least in part on the first query and the previous query further comprises:
appending, using the one or more computing devices, the previous query to the first query to generate a third query; and
providing, using the one or more computing devices, the third query to an advertisement retrieval system.

12. The method of claim 1, wherein at least one of the first query or the previous query comprises information that characterizes a web page that was visited by the user.

13. The method of claim 1, wherein at least one of the first query or the previous query comprises a search query received from a device of the user.

14. A computer-implemented method for contextualizing geocodable queries, the method comprising:
receiving, using one or more computing devices, a first query associated with a user;
providing, using the one or more computing devices, the first query to a location extraction module;
receiving, using the one or more computing devices, a first indication from the location extraction module of whether the first query exclusively comprises terms that are associated with geolocations;
when the first indication indicates that the first query exclusively comprises the terms that are associated with the geolocations, providing, using the one or more computing devices and to an advertisement retrieval system, the first query and a second indication that the first query should be combined with a previous query associated with the user, otherwise providing, using the one or more computing devices, the first query to the advertisement retrieval system; and
receiving, using the one or more computing devices, an advertisement from the advertisement retrieval system.

15. The method of claim 14, further comprising:
determining, using the one or more computing devices, a topic corresponding to the previous query associated with the user; and
determining, using the one or more computing devices, whether the topic corresponding to the previous query satisfies a topic criterion that is independent of the first query.

16. The method of claim 15, wherein the providing, using the one or more computing devices and to the advertisement retrieval system, the first query and the second indication that the first query should be combined with the previous query associated with the user further comprises:
exclusively when the previous query satisfies the topic criterion, providing, using the one or more computing devices and to the advertisement retrieval system, the first query and the second indication that the first query should be combined with the previous query associated with the user.

17. The method of claim 15, wherein the determining, using the one or more computing devices, whether the topic corresponding to the previous query satisfies the topic criterion that is independent of the first query further comprises:
determining, using the one or more computing devices, whether the topic is included in a topic whitelist.

18. The method of claim 14, further comprising:
retrieving, using the one or more computing devices and at least partially contemporaneous to the providing, a search result based at least in part on the first query and exclusive of the previous query.

19. A system, comprising:
one or more processors; and
a memory including instructions that, when executed by the one or more processors, cause the one or more processors to:
receive a search term associated with a user;
determine whether the search term is geocodable such that the search term is capable of being geocoded;
when the search term is not geocodable, retrieve an advertisement based at least in part on the search term;
when the search term is geocodable;
determine a previous query associated with the user; and
retrieve an advertisement based at least in part on the search term and the previous query.

20. The system of claim 19, wherein the memory further includes instructions that, when executed by the one or more processors, cause the one or more processors to:
determine a topic based at least in part on the previous query;
determine whether the topic satisfies a topic criterion that is independent of the search term; and
when the topic fails to satisfy the topic criterion, retrieve the advertisement based at least in part on the search term and exclusive of the previous query.

21. The system of claim 19, wherein the memory further includes instructions that, when executed by the one or more processors, cause the one or more processors to:
perform, at least partially contemporaneous to the retrieve, a search based at least in part on the search term and exclusive of the query.

22. A non-transitory machine readable medium embodying instructions that, when executed by a machine, cause the machine to perform a method for contextualizing geocodable queries, the method comprising:
providing a first query that relates to a topic;
providing a second query that exclusively comprises geocodable terms, the second query being provided after the first query;
receiving a search result based at least in part on the second query;
when the first query satisfies a criterion, based on the topic, that is independent of the second query, receiving a first advertisement that is selected based at least in part on the first query and the second query; and
when the first query does not satisfy the criterion, receiving a second advertisement, distinct from the first advertisement, that is selected based at least in part on the second query and exclusive of the first query.

23. The machine readable medium of claim 22, wherein the first query comprises information that characterizes a presented web page.
